(19) United States
(12) Patent Application Publication
(10) Pub. No.: US 2005/0034576 A1
(43) Pub. Date: Feb. 17, 2005

(54) Bun slicer

(76) Inventors: Theodore M. Ray, Rowlett, TX (US); David E. Bishop, Dallas, TX (US); James T. Henry, Greenville, TX (US)

Correspondence Address: ANDERSON, LEVINE & LINTEL L.L.P., 14785 PRESTON ROAD, SUITE 650, DALLAS, TX, 75254, US

(21) Appl. No.: 10/638,580

(22) Filed: Aug. 11, 2003

(51) Int. Cl. B26D 7/06

(52) U.S. Cl. 83/13; 83/435.2; 83/932

(57) ABSTRACT

A bun slicing device includes a conveyor belt for conveying buns over a table. At least a portion of the table provides a suction, which draws air through the buns. The buns are sliced while over the suction portion, so that air is passing through the buns as they are sliced. The suction holds the buns to the table and also holds the resulting bun sections together, such that the sections do not separate during slicing.

### CROSS-REFERENCE TO RELATED APPLICATIONS

Not Applicable

### STATEMENT OF FEDERALLY SPONSORED RESEARCH OR DEVELOPMENT

Not Applicable

### BACKGROUND OF THE INVENTION

1. Technical Field

This invention relates in general to bread slicing machines and, more particularly, to a bun slicing machine.

2. Description of the Related Art

In the fast food industry it is common to use buns that are sliced twice to make a “double decker” sandwich, such as the BIG MAC from McDonalds Corporation. Naturally, the buns are sliced using a high speed bun slicing machine that feeds into a packaging device.

FIG. 1 illustrates, in pertinent part, the workings of a prior art slicing machine 10 for double-cut buns. Buns 11 are placed between two conveyor belts 12a-b which hold the bun in place as it is being cut by upper and lower blades 14a and 14b, respectively. To hold the bun in place such that the top of the bun does not fly off during cutting the upper conveyor belt 12a must exert pressure on the top of the buns 11, causing the bun to vertically compress. After the bun pass through the blades 14a-b, the sliced bun has three bun sections, upper section 16a, middle section 16b, and bottom section 16c. The resulting flattened, unattractive, bun is all too familiar to consumers.

Therefore, a need has arisen in the industry for a bun slicing apparatus that does not flatten or cup buns during slicing.

### BRIEF SUMMARY OF THE INVENTION

In the present invention, a bun slicing machine comprises a table having at least a portion through which air is drawn. A conveyor conveys buns on the table, wherein air is drawn through the conveyor. A blade assembly has one or more cutting surfaces disposed to slice the buns into vertically stacked sections as air is drawn through the buns, such that the air holds the buns to the conveyor and holds sections of the buns together as the buns are sliced.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 is a side view of a prior art bun slicing device;

FIG. 2a is a top view of an improved bun slicing device; and

FIG. 2b is a cross-section side view of the bun slicing device of FIG. 2a;

FIG. 3a is a top view of a table for providing a suction to the buns;

FIG. 3b is a cross-sectional side view of the table of FIG. 3a;

FIG. 4a is a top view of a coney slicing device; and

FIG. 4b is a top view of the blade driving apparatus used in FIG. 4a.

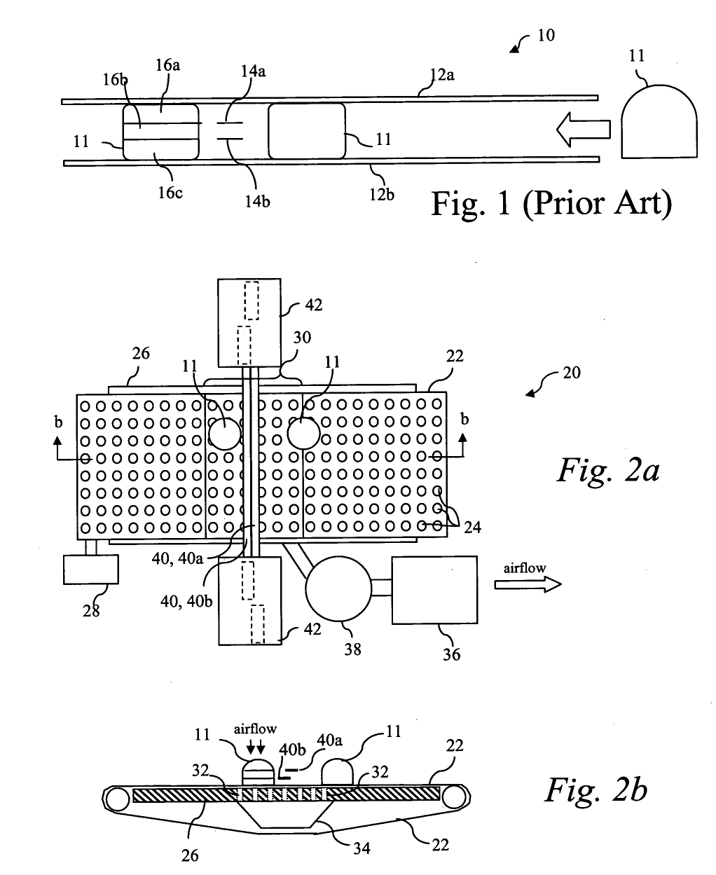

### DETAILED DESCRIPTION OF THE INVENTION

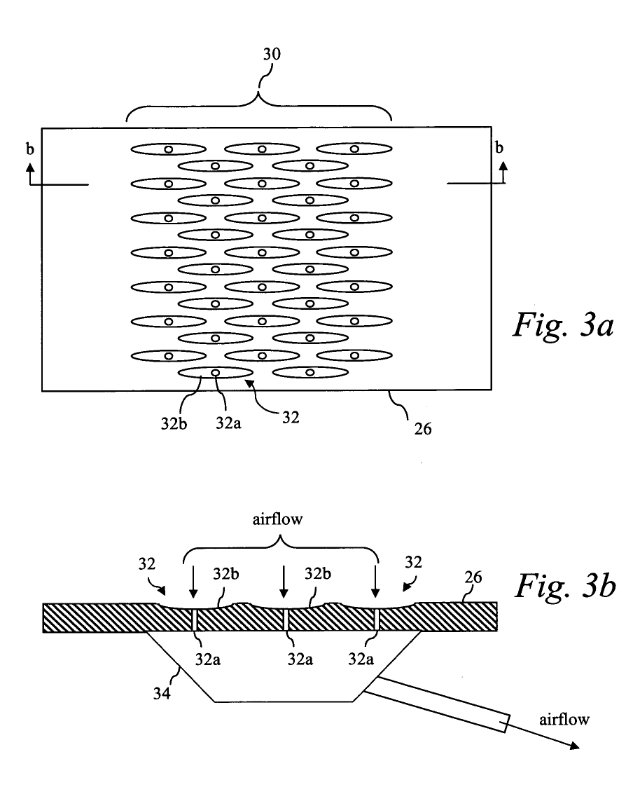

The present invention is best understood in relation to FIGS. 2a through 3b of the drawings, like numerals being used for like elements of the various drawings.

FIGS. 2a and 2b illustrate top and cross-sectional side views of a bun slicing device 20. Buns are placed on a conveyor belt 22 that has holes 24 (or other type of perforation) formed therethrough. The conveyor belt 22 loops around a table 26 and is driven by motor 28. Table 26 includes a vacuum section 30 (shown in greater detail in connection with FIGS. 3a and 3b) in which openings 32 are formed through the table 26 for communication with vacuum chamber 34. Vacuum chamber 34 is coupled to air blower 36 through filter 38. Air blower 36 draws air downwardly through openings 32. For a double-cut bun, there are two blades 40. Upper blade 40a and lower blade 40b are disposed horizontally across table 26 and are driven by blade motor assembly 42. Preferably, upper blade 40a has a cutting edge that leads lower blade 40b by 1/4 inch or more. For a single cut bun, only one blade 40 is needed.

The upper blade 40a and lower blade 40b could be two separate blades, or different portions of a single continuous blade loop. Using two separate blades may facilitate positioning the blades at a desired horizontal offset.

In operation, as buns 11 are placed on the conveyor belt 22, they are transported towards blades 40a and 40b, which are moving at high speed. As buns move over the vacuum section 30, the buns 11 are held in place by the vacuum generated by the blower 36 as it draws air through openings 32 and through holes 24. Since the buns 11 themselves are porous, air flows through the bun from top to bottom while the buns are over the vacuum section. As the conveyor belt 32 transports the buns through blades 40a and 40b, the upper and middle sections 16a and 16b of the bun 11 are held together by the force of the air being drawn through the bun 11. This prevents the two sections of the bun 11 from spinning off under force of the moving blade 40.

After the buns are sliced and are conveyed past the vacuum section 30, they may be conveyed to a conventional automatic packaging device (not shown).

Filter 38 stops crumbs from the slicing process from entering the blower 36.

In the preferred embodiment, the cutting edge of the upper blade 40a leads the cutting edge of the lower blade 40b. This has been found to reduce the amount of suction needed to hold the bun sections together during the slicing process.

The force of the suction which keeps the bun together during the slicing process does not deform the buns in any significant manner. Therefore, the sliced buns remain in their just-baked shape, which is significantly more appetizing than a flattened bun. Also, since the buns are not compressed during the slicing process, the resulting cuts are cleaner, with little or no ripping on the edges, as frequently occurs with prior art devices.

FIGS. 3a and 3b illustrate cross a top view and a cross-sectional side view of the vacuum section 30 of the table 26. Blower 36 is coupled to vacuum chamber 34, which is in communication with openings 32. Openings 32 include a borehole 32a and an elongated channel 32b. As the conveyor belt 22 passes over an opening 32, air will be drawn through a hole 24 so long as the hole 24 is above any part of the channel 32b; thus, the hole does not need to be directly over a borehole 32a in order to communicate the suction to the bun 11. Alternatively, the vacuum section 38 could provide a greater number of boreholes 32a without channels 32b, such that the density of the boreholes 32a ensured that a hole 24 of conveyor belt 22 would be above a borehole 32a while the hole 24 was in the vacuum section 30.

While the bun slicing device 20 has been discussed primarily in connection with double sliced buns, it could also be used in connection with the more conventional single slice buns. Using the vacuum to hold the buns 11 to the conveyor belt 22 and to hold the bun halves together eliminates the need for a compressive force to be placed in the top of the bun. By not compressing the bun 11 during slicing, the resulting sliced bun is fluffier and more visually appealing.

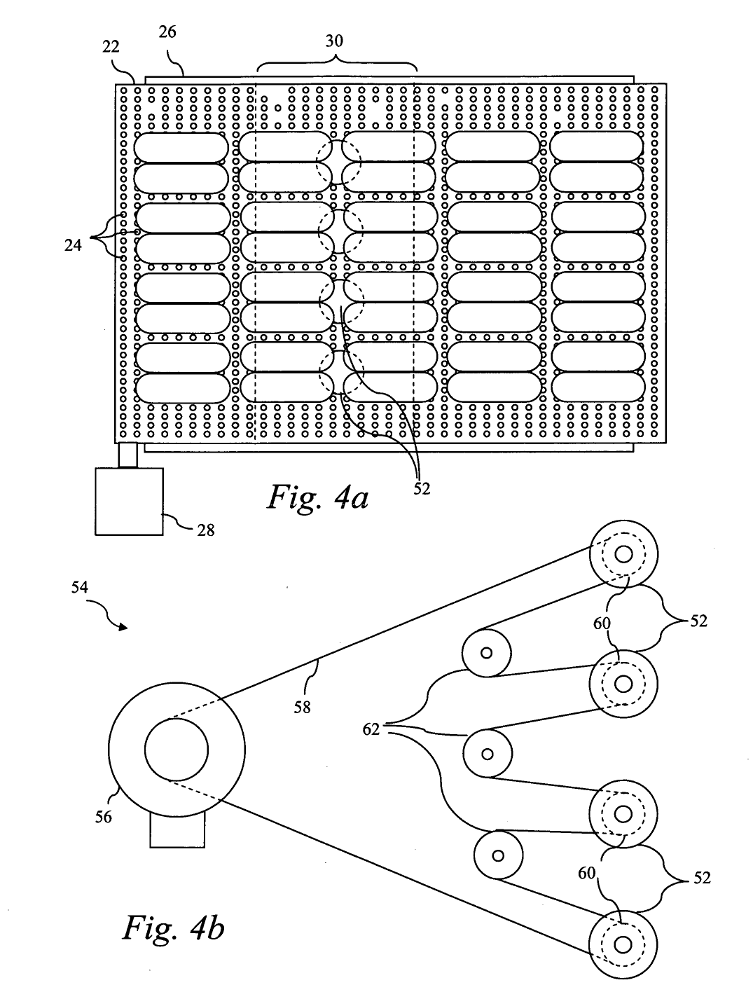

FIGS. 4a and 4b illustrate an embodiment of the invention for cutting coney buns 50. The buns 50 are placed on a conveyor belt 22 that has holes 24 (or other type of perforation) formed therethrough. The conveyor belt 22 loops around a table 26, driven by motor 28. Table 26 includes a vacuum section 30 in which openings 32 are formed through the table 26 for communication with vacuum chamber 34 (as shown in FIGS. 3a and 3b). Rotary cutting blades 52 are disposed between rows of coney buns 50, such that pairs of buns are sliced simultaneously by each blade 52.

In operation, as buns 50 are placed on the conveyor belt 22, they are transported in pairs towards blades 52, which are rotating at high speed. As buns 50 move over the vacuum section 30, the buns 50 are held in place by the vacuum. After the buns are sliced and are conveyed past the vacuum section 30, they may be conveyed to a conventional automatic packaging device (not shown).

FIG. 4b illustrates a diagram of a blade assembly 54 that could be used to rotate blades 52. Motor 56 drives belt 58. Belt 58 travels around cutter drive pulleys 60, coupled to rotary cutting blades 52, and pulleys 62, disposed between drive pulleys to provide tension to the drive belt 58.

In operation, as the drive belt 58 is rotated by motor 56, the rotary cutting blades 52 rotate at high speed. The buns 50 are transported past the blades in pairs, the rotary blades 52 slice the buns (partially) to receive a coney or other sausage-shaped food product. The vacuum holds both halves of the buns 50 such a smooth cut is formed and so that the friction involved in the cutting does not separate the bottom half of the bun from the top half.

The present invention provides significant advantages over the prior art. Significantly, buns are not flattened or cupped as they are sliced, resulting in a more attractive and tasty bun.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the claims.

1. A bun slicing machine comprising:
a table having at least a portion through which air is drawn;
a conveyor for conveying buns on the table, wherein air is drawn through the conveyor;
a blade assembly having one or more cutting devices disposed to slice the buns into vertically stacked sections as air is drawn through the buns, such that the air holds the buns to the conveyor and holds sections of the buns together as the buns are sliced.

2. The bun slicing machine of claim 1 wherein the blade assembly includes one cutting edge for cutting a single slice through the buns.

3. The bun slicing machine of claim 1 wherein the blade assembly includes upper and lower cutting edges for cutting two slices through the buns.

4. The bun slicing machine of claim 3 wherein one of the cutting edges is disposed horizontally in front of the other cutting edge.

5. The bun slicing machine of claim 4 wherein the upper cutting edge is disposed horizontally in front of the lower cutting edge, such that an upper slice through the bun is started before a lower slice through the bun.

6. The bun slicing machine of claim 1 wherein the portion of the table has openings formed therethrough.

7. The bun slicing machine of claim 6 wherein at least some of the opening include a borehole portion and a channel portion.

8. The bun slicing machine of claim 1 wherein the conveyor is perforated such that air is drawn through buns placed on the conveyor.

9. The bun slicing machine of claim 1 wherein the blade assembly includes a plurality of rotary blades.

10. The bun slicing machine of claim 9 wherein the rotary blades each cut pairs of buns simultaneously.

11. A method of slicing buns, comprising the steps of:
drawing air through at least a portion of a table;
conveying buns on the table, wherein air is drawn through the conveyor and the buns;
slicing the buns into vertically stacked sections as air is drawn through the buns, such that the air holds the buns to the conveyor and holds sections of the buns together as the buns are sliced.

12. The method of claim 11 wherein the slicing step comprises the step of slicing the buns with a blade assembly including one cutting edge for cutting a single slice through the buns.

13. The method of claim 11 wherein the slicing step comprises the step of slicing the buns with a blade assembly including upper and lower cutting edges for cutting two slices through the buns.

14. The method of claim 13 wherein the slicing step comprises the step of slicing the buns with a blade assembly including upper and lower cutting edges for cutting two slices through the buns and one of the cutting edges is disposed horizontally in front of the other cutting edge.

15. The method of claim 14 wherein the upper cutting edge is disposed horizontally in front of the lower cutting edge, such that an upper slice through the bun is started before a lower slice through the bun.

16. The method of claim 11 wherein the slicing step comprises the step of slicing the buns with a blade assembly including a plurality of rotary blades.

17. The method of claim 16 wherein the slicing step comprises the step of slicing buns with a blade assembly including a plurality of rotary blades, and wherein the rotary blades each cut pairs of buns simultaneously.
